(19) United States
(12) Patent Application Publication
(10) Pub. No.: US 2021/0384615 A1
(43) Pub. Date: Dec. 9, 2021

(54) ANTENNA PACKAGING MODULE AND ELECTRONIC DEVICE

(71) Applicant: GUANGDONG OPPO MOBILE TELECOMMUNICATIONS CORP., LTD., Dongguan (CN)

(72) Inventor: Yuhu JIA, Dongguan (CN)

(21) Appl. No.: 17/405,806

(22) Filed: Aug. 18, 2021

Related U.S. Application Data
(63) Continuation-in-part of application No. PCT/CN2020/079502, filed on Mar. 16, 2020.

(30) Foreign Application Priority Data
Mar. 20, 2019 (CN) 201910211411.8

(51) Int. Cl. H01Q 1/24; H01Q 1/38; H01Q 5/371; H01Q 1/48

(52) U.S. Cl. CPC H01Q 1/243; H01Q 1/48; H01Q 5/371; H01Q 1/38

(57) ABSTRACT

An antenna packaging module and an electronic device are provided. The antenna packaging module includes: an antenna substrate, a radiator, a second laminated circuit, a feed structure, and a conductive array assembly. A first laminated circuit and a ground layer are disposed on two opposite sides of the antenna substrate, respectively. The radiator is disposed on a side of the first laminated circuit away from the antenna substrate. The second laminated circuit is disposed on a side of the ground layer away from the antenna substrate. The feed structure extends through the second laminated circuit, the ground layer, the antenna substrate and the first laminated circuit. The feed structure electrically connects a radio frequency chip and the radiator. The conductive array assembly includes a number of conductive structures. The conductive structures extend through the antenna substrate and are electrically connected with the ground layer.

### CROSS-REFERENCE TO RELATED APPLICATION

This application is a continuation-in-part of International Application No. PCT/CN2020/079502, filed Mar. 16, 2020, which claims priority to Chinese Patent Application No. 201910211411.8, filed Mar. 20, 2019, the entire disclosures of which are incorporated herein by reference.

### TECHNICAL FIELD

The disclosure relates to the technical field of antenna, and more particularly, to an antenna packaging module and electronic device.

### BACKGROUND

Provided here is background information relevant to the disclosure and does not necessarily constitutes the exemplary prior art.

With the development of wireless communication technology, technology of 5G network has emerged. As the fifth-generation mobile communication network, 5G network has a theoretical peak transmission speed up to tens of Gb per second, which is hundreds of times faster than the transmission speed of 4G network. Therefore, millimeter wave band with sufficient spectrum resources has become one of operating bands for 5G communication system.

Millimeter-wave packaging antenna module is a mainstream packaging solution for future 5G millimeter wave electronic devices. The millimeter wave packaging antenna module can adopt a high-density interconnection process of a multilayer PCB and dispose a radiator on a side of the module. However, the radiator generally takes a microstrip patch antenna array. A size of the microstrip patch antenna array is mainly limited by a dielectric constant of the multilayer PCB board, and radiation efficiency of the microstrip patch antenna array is relatively low.

### SUMMARY

The disclosure provides an antenna device and an electronic device, according to various embodiments.

An antenna packaging module includes: an antenna substrate, a radiator, a first laminated circuit a second laminated circuit, a feed structure, and a conductive array assembly. The first laminated circuit and a ground layer are disposed on two opposite sides of the antenna substrate, respectively. The radiator is disposed on a side of the first laminated circuit away from the antenna substrate. The second laminated circuit is disposed on a side of the ground layer away from the antenna substrate. The feed structure extends through the second laminated circuit, the ground layer, the antenna substrate and the first laminated circuit, and the feed structure electrically connects a radio frequency chip and the radiator. The conductive array assembly comprises a number of conductive structures, the conductive structures extend through the antenna substrate and are electrically connected with the ground layer, and a portion of the feed structure being disposed in a space formed by two adjacent conductive structures.

An electronic device is further provided. The electronic device includes a housing and the above-mentioned antenna packaging module. The antenna packaging module is accommodated in the housing.

The antenna packaging module and the electronic device includes: an antenna substrate, a radiator, a second laminated circuit, a feed structure, and a conductive array assembly. A first laminated circuit and a ground layer are disposed respectively on two opposite sides of the antenna substrate. The radiator is disposed on a side of the first laminated circuit away from the antenna substrate. The second laminated circuit is disposed on a side of the ground layer away from the antenna substrate, and a side of the second laminated circuit away from the ground layer is configured to dispose a radio frequency chip. The feed structure extends through the second laminated circuit, the ground layer, the antenna substrate and the first laminated circuit, the feed structure is configured to connect the radio frequency chip and the radiator. The conductive array assembly includes a number of spaced conductive structures, the conductive structures extend through the antenna substrate and are connected with the ground layer, and a portion of the feed structure is disposed in a space formed by two adjacent conductive structures.

Details of one or more embodiments of the disclosure will be described in the following drawings and description. Other features, objects and advantages of the disclosure will become more apparent from the description, the drawings, and the claims.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, and other drawings can also be obtained by those skilled in the art according to these drawings without any creative effort.

FIG. 1 is a stereo diagram of an electronic device according to an embodiment of the disclosure;

FIG. 2 is a schematic structural diagram of an antenna packaging module according to an embodiment of the disclosure;

FIG. 3a is a schematic diagram showing the structure of conductive sheets, according to an embodiment of the disclosure;

FIG. 3b is a schematic diagram showing the structure of conductive sheets, according to another embodiment of the disclosure;

FIG. 3c is a schematic diagram showing the structure of conductive sheets, according to still another embodiment of the disclosure;

FIG. 3d is a schematic diagram showing the structure of conductive sheets, according to another embodiment of the disclosure;

FIG. 3e is a schematic diagram showing the structure of conductive sheets, according to still another embodiment of the disclosure;

FIG. 4 is a schematic structural diagram of an antenna packaging module according to another embodiment of the disclosure;

FIG. 5 is a main view of a housing according to another embodiment of the disclosure, wherein the housing is included in an electronic device; and

FIG. 6 is a block diagram showing partial structure of a mobile phone, which is relevant to the electronic device provided in the embodiments of the disclosure.

### DETAILED DESCRIPTION OF THE EMBODIMENTS

In order to more clearly and obviously illustrate objects, technical solutions and advantages of the disclosure, the disclosure will be further described in detail below with reference to the accompanying drawings and embodiments. It should be understood that the specific embodiments described herein are merely used to explain the disclosure, but not to limit the disclosure.

It should be understood that terms such as “first”, “second”, etc. are used herein for describing various elements, but these elements should not be limited by these terms. These terms are only used for distinguishing one element from another element, and are not intended to indicate or imply relative importance or to imply the number of indicated technical features. Thus, the feature defined with “first” and “second” may explicitly or implicitly include at least one such feature. In the description of the disclosure, “a number of” means two or more than two, such as two and three, unless expressly specified otherwise.

It should be noted that when an element is described to be arranged to another element, the element may be directly arranged on another component or there may be an intermediate element. When an element is considered to be connected to another element, the element may be directly connected to another component or there may be an intermediate element.

An antenna module according to an embodiment of the disclosure is applied to an electronic device. In an embodiment, the electronic device may include a mobile phone, a tablet computer, a notebook computer, a palmtop computer, a mobile Internet device (MID), a wearable device (such as a smart watch, a smart bracelet, a pedometer, etc.) or other communication modules provided with an array antenna module.

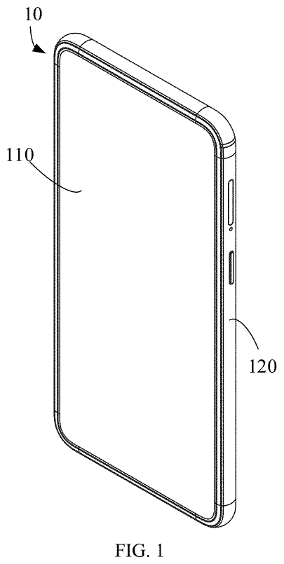

As illustrated in FIG. 1, an electronic device 10 provided in an embodiment of the disclosure may include a display assembly 110, a housing assembly 120 and a controller. The display assembly 110 is fixed to the housing assembly 120 and forms an external structure of the electronic device together with the housing assembly 120. The housing assembly 120 may include a middle frame and a rear cover. The middle frame may be a frame structure having a through hole. The middle frame may be accommodated in an accommodating space formed by the display assembly 110 and the rear cover. The rear cover is used to form an external profile of the electronic device. The rear cover may be formed integrally. In a molding process of the rear cover, a rear camera hole, a fingerprint identification module, an antenna module mounting hole and other structures may be formed in the rear cover. The rear cover may be a non-metallic rear cover. For example, the rear cover may be a plastic rear cover, a ceramic rear cover, a 3D glass rear cover, and so on. The controller is configured to control an operation of the electronic device 10. The display assembly 110 may be used to display pictures or texts, and may provide a user with an operation interface.

In an embodiment, the housing assembly 120 is integrated with an antenna packaging module. The antenna packaging module can transmit and receive millimeter wave signals through the housing assembly 120, such that the electronic device 10 may achieve a wide coverage of the millimeter wave signals.

The millimeter wave refers to an electromagnetic wave with a millimeter-level wavelength, and a frequency of the millimeter wave is approximately between 20 GHz and 300 GHz. The 3rd Generation Partnership Project (3GPP) has specified a list of frequency bands supported by 5G New Radio (NR), and spectrum range of 5G NR is up to 100 GHz. 5G NR supports two major frequency bands: frequency range 1 (FR1), i.e., a sub 6 GHz frequency band, and frequency range 2 (FR2), i.e., a millimeter wave frequency band. The frequency range of FR1 frequency band is 450 MHz-6 GHz, and the maximum channel bandwidth is 100 MHz. The frequency range of FR2 is 24.25 GHz-52.6 GHz, and the maximum channel bandwidth is 400 MHz. A nearly 11 GHz spectrum used for 5G mobile broadband includes: 3.85 GHz licensed spectrum, such as: 28 GHz (24.25-29.5 GHz), 37 GHz (37.0-38.6 GHz), 39 GHz (38.6-40 GHz) and 14 GHz unlicensed spectrum (57-71 GHz). 5G communication system operates in three bands as follows: 28 GHz, 39 GHz, and 60 GHz.

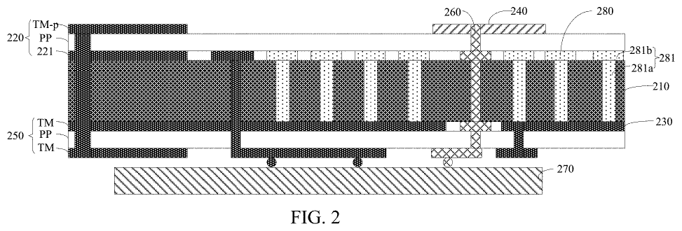

As illustrated in FIG. 2, an embodiment of the disclosure provides an antenna packaging module. The antenna packaging module includes an antenna substrate 210, a first laminated circuit 220, a ground layer 230, a radiator 240, a second laminated circuit 250, a feed structure 260, a radio frequency chip 270 and a conductive array assembly 280.

In an embodiment, the antenna substrate 210, the first laminated circuit 220, the ground layer 230, and the second laminated circuit 250 may be integrated in a multilayer printed circuit board (PCB) which is integrated by a high-density interconnect (HDI) process. The multilayer PCB may include a core layer, prepreg (PP) layers laminated respectively on two sides of the core layer, and metal layers TM plated on each PP layer and the core layer. The PP layer is a semi-cured sheet disposed between two copper layers. The two copper layers are attached to two opposite sides of the PP layer, respectively, and the two copper layers are insulated from each other. The metal layer TM can be a copper layer, a tin layer, a lead-tin alloy layer, a tin-copper alloy layer, etc.

In an embodiment, the antenna substrate 210 may be considered as the core layer. The antenna substrate 210 includes a first surface and a second surface opposite to the first surface. The first laminated circuit 220 is disposed on the first surface of the antenna substrate 210. In other embodiments, the first laminated circuit 220 may include a number of spaced metal layers TM and PP layers, where the metal layer TM is arranged above the PP layer.

In an embodiment, the ground layer 230 is disposed on the second surface of the antenna substrate 210.

In an embodiment, the second laminated circuit 250 is disposed on a side of the ground layer 230 away from the antenna substrate 210. A side of the second laminated circuit 250 away from the ground layer 230 is configured to dispose a radio frequency chip 270. In other embodiments, the second laminated circuit 250 may include a number of spaced metal layers TM and PP layers. The metal layer TM is arranged above the PP layer, or the metal layer TM is arranged below the PP layer.

In an embodiment, a radiator 240 is disposed on a side of the first laminated circuit 220 away from the antenna substrate 210. Specifically, the radiator 240 is disposed on the top metal layer TM-p to receive and transmit millimeter wave signals. The radiator 240 is further provided with a feed point for feeding current signals. The feed point is connected to the radio frequency chip 270 via the feed structure 260.

In an embodiment, the radiator 240 may be a phased antenna array configured to radiate millimeter wave signals. For example, the radiator 240, which is configured to radiate the millimeter wave signals, may be an antenna array formed by antennas selected from types of a patch antenna, a dipole antenna, a yagi antenna, a beam antenna, or other suitable antenna elements.

The feed structure 260 extends through the second laminated circuit 250, the ground layer 230, the antenna substrate 210 and the first laminated circuit 220 to connect the radio frequency chip 270 and the radiator 240. The feed structure 260 extends through the two opposite sides of the antenna substrate 210. An end of the feed structure 260 connects to the radio frequency chip 270, and the other end of the feed structure 260 connects to the radiator 240.

In an embodiment, the second laminated circuit 250, the ground layer 230, the antenna substrate 210 and the first laminated circuit 220 may define a number of through holes therein. A location of the through hole on the first laminated circuit 220 is set corresponding to a location of the feed point. Conductive material is filled in the through holes to form the feed structure 260, and the radio frequency chip 270 and the radiator 240 are conducted via the feed structure 260. That is, the feed structure 260 is disposed in the though holes. The radio frequency chip 270 is connected to the radiator 240 via the feed structure 260 to feed current signals into the radiator 240, thereby receiving and transmitting the millimeter wave signals.

The conductive array assembly 280 includes a number of spaced conductive structures 281, the conductive structures 281 extends through the antenna substrate 210 and connect to the ground layer 230. A portion of the feed structure 260 is disposed in a space formed by two adjacent conductive structures 281.

In an embodiment, material of the conductive structures 281 may be a conductive material, such as a metallic material, an alloy material, a conductive silicone material, a graphite material, etc. In this embodiment, the material of the conductive structures 281 may be copper.

By introducing the conductive array assembly 280 in the antenna substrate 210, the aforementioned antenna packaging module can suppress a surface wave, that is, the antenna packaging module has characteristics of high impedance for the surface wave in a certain frequency band. Specifically, the antenna packaging module has a suppressive effect on the surface wave of a surface propagation frequency within an attenuation band, or cannot support propagation of the surface wave of a frequency band within the attenuation band, and then an antenna radiation efficiency is improved, thereby improving an antenna gain. The surface wave is a guided wave propagating along an interface between two media. A medium substrate of a plane antenna can restrict part of electromagnetic wave to propagate at the interface between medium and air. Meanwhile, the introduced conductive array assembly 280, which can be considered as a number of parallel LC circuits, can improve the impedance bandwidth of the antenna and enhance isolation between ports of the antenna. By introducing the conductive array assembly 280, size of the radiator 240 along a non-scanning direction can be reduced, thereby reducing a volume of the entire antenna packaging module.

In an embodiment, the first laminated circuit 220 includes a first conductive layer 221 adjacent to a side of the antenna substrate 210. The first conductive layer 221 can be considered as a metal layer TM disposed adjacent to the antenna substrate 210. The metal layer TM can be a copper layer, a tin layer, a lead-tin alloy layer, a tin-copper alloy layer, etc.

Specifically, the conductive structure 281 includes a conductive column 281a extending through the antenna substrate 210 and a conductive sheet 281b disposed on the first conductive layer 221. The conductive sheet 281b is connected to the ground layer 230 via the conductive column 281a. In an embodiment, the conductive columns 281a are parallel to each other. Further, each of the conductive columns 281a is parallel to an extending direction of a portion of the feed structure 260 in the antenna substrate 210. In an embodiment, an area of the conductive sheet 281b is larger than an area of a cross section of the conductive column 281a, where the cross section is along a plane of the antenna substrate 210.

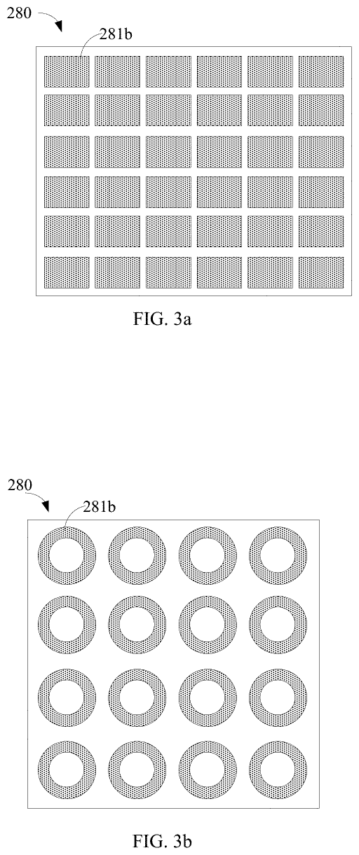

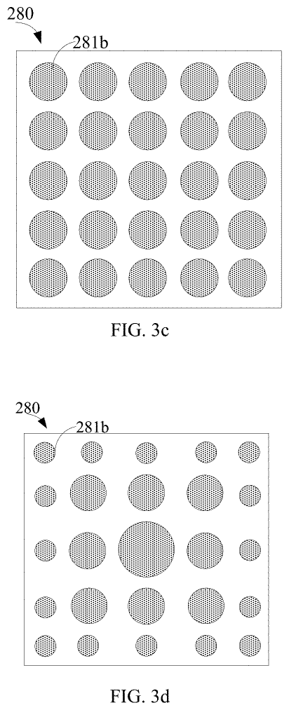

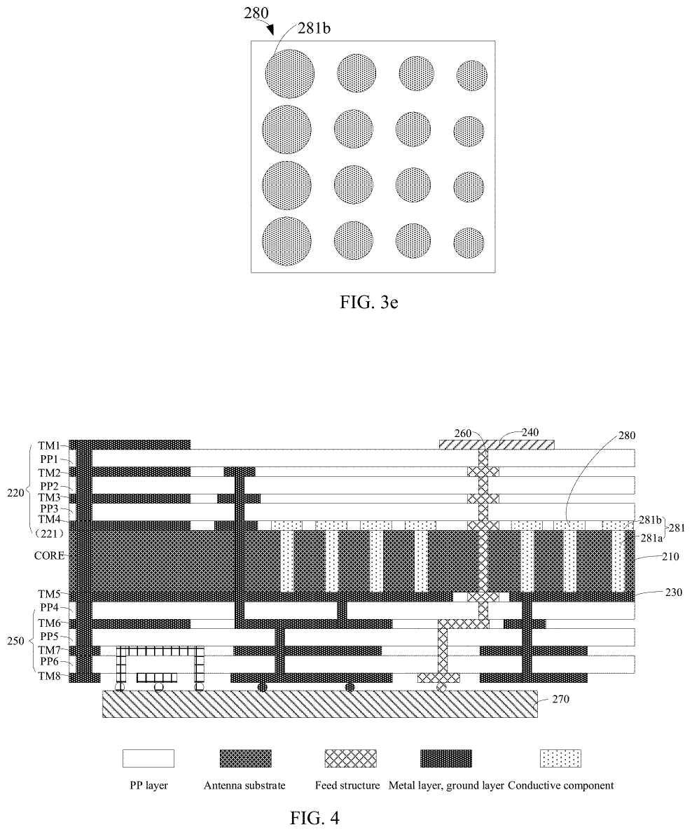

As illustrated in FIG. 3a, FIG. 3b and FIG. 3c, a shape of the conductive sheet 281b may include at least one of a rectangle (shown in FIG. 3a), an annulus (shown in FIG. 3b), a circle (shown in FIG. 3c), an ellipse, a mushroom shape, an inverted “H” shape, and a cross shape. In the embodiments of the disclosure, the shape of the conductive sheet 281b may be set according to an actual demand, and is not limited to the above examples.

It should be noted that a size of the conductive sheet 281b is related to thickness and dielectric constant of the antenna substrate 210. In the embodiments of the disclosure, the size of the conductive sheet 281b is not further limited. A resonant frequency of the radiator 240 can be adjusted by adjusting the sizes of the conductive sheets 281b, the thickness and the dielectric constant of the antenna substrate 210.

In an embodiment, the conductive columns 281a are in one-to-one correspondence with the conductive sheets 281b. The conductive structures 281 are electrically connected to a radiator 240 via the conductive columns 281a. Specifically, the antenna substrate 210 defines a number of through holes, and conductive material are filled in the through holes to form conductive columns 281a. The conductive columns 281a are in one-to-one correspondence with the conductive sheets 281b. The conductive structures 281 are electrically connected to the ground layer 230 via the conductive columns 281a to achieve a common ground for the conductive sheets 281b via the conductive columns 281a. Meanwhile, the spaced conductive sheets 281b are respectively independent and not connected to each other, thereby achieving a mutual capacitive coupling between the conductive sheets 281b. Further, the conductive structures are spaced apart from each other.

In an embodiment, a shape of a cross section of the conductive column 281a along a plane of the antenna substrate is the same as a shape of the conductive sheet 281b connected to the conductive column 281a. That is, the conductive column 281a may be considered as the conductive sheet 281b with greater thickness, and the thickness of the conductive column 281a is the thickness of the antenna substrate 210. For example, in a condition that the shape of the conductive sheet 281b is a circular, the shape of the conductive column 281a connected to the conductive sheet 281b is a cylindrical. The material of the conductive columns 281a, which is formed by filling the conductive material in the through hole, is the same as the material of the conductive structure 281. For example, the material may be a metal material, a graphite material, etc.

In an embodiment, a number of the conductive sheets 281b are periodically arranged on a first conductive layer 221. For example, the conductive sheets may be arranged as a honeycomb arrangement structure, a diamond arrangement structure, a rectangular arrangement structure, a radial arrangement structure, a gradient arrangement structure, etc. Each of the conductive sheets 281b in a conductive array assembly 280 may be same or different in shape. For example, the periodically arranged conductive sheets 281b are rotationally symmetric or axially symmetric in a plane.

In an embodiment according to FIG. 3a, each of the periodically arranged conductive sheets 281b in a plane is same in shape, and an area of each of the periodically arranged conductive sheets 281b is equal. For example, the conductive sheets 281b in the conductive array assembly 280 are arranged in a two-dimensional array.

In an embodiment provided in FIG. 3d, each of the conductive sheets 281b in the conductive structure 281 is same in shape, an area of the conductive sheet 281b located at a center of the conductive array assembly 280 is the largest, and areas of the conductive sheets 281b decrease gradually along a direction radiating from the center to the periphery. For example, the conductive sheets 281b in the conductive array assembly 280 are arranged in a two-dimensional rectangular array of M*M, the shape of each of the conductive sheets 281b in the conductive array assembly 280 is circular, a center-to-center distance between two adjacent conductive sheets 281b is equal, or an edge-to-edge distance between two adjacent conductive sheets 281b is equal. M may be 4, 5, 6 or an integer greater than 6. In the embodiments of the disclosure, the shape of the conductive sheet 281b, and the value of M are not further limited.

In this embodiment, by arranging the conductive array assembly 280 in a two-dimensional rectangular array of M*M where the conductive sheets 281b gradually change in two dimensions, the impedance bandwidth and gain of the antenna packaging module can be improved simultaneously, a beam width of a main lobe of the antenna packaging module can be diminished, and a directionality of the antenna packaging module can be enhanced.

In an embodiment provided in FIG. 3e, each of the conductive sheets 281b in the conductive array assembly 280 is same in shape, and areas of the conductive sheets 281b in each row of the conductive array assembly 280 gradually decreases along a direction. For example, the conductive sheets 281b in the conductive array assembly 280 are arranged in a two-dimensional rectangular array of M*M, and the shape of each of the conductive sheets 281b is rectangular. In the two-dimensional rectangular array of M*M provided in an embodiment, the areas of the conductive sheets 281b gradually reduce along a row direction from the first row to the M-th row, or the areas of the conductive sheets 281b gradually enlarge along the row direction. A trend of enlarging areas of the two adjacent conductive sheets 281b along the row direction is the same, or a trend of reducing areas of the two adjacent conductive sheets 281b along the row direction is the same, that is, the areas are reduced in a same proportion or the areas are enlarged in a same proportion. In each row of the two-dimensional rectangular array of M*M, a difference between the areas of any two adjacent conductive sheets 281b is same, or a ratio between the areas of any two adjacent conductive sheets 281b is same.

In a two-dimensional rectangular array of M*M provided in another embodiment, the areas of the conductive sheets 281b gradually reduce along a column direction from the first column to the M-th column, or the areas of the conductive sheets 281b enlarge along the column direction. A trend of enlarging areas of the two adjacent conductive sheets 281b along the column direction is the same, or a trend of reducing areas of the two adjacent conductive sheets 281b along the column direction is the same, that is, the areas are reduced in a same proportion or the areas are enlarged in a same proportion. In each column of the two-dimensional rectangular array of M*M, a difference between the areas of any two adjacent conductive sheets 281b is same, or a ratio between the areas of any two adjacent conductive sheets 281b is same.

Further, in the two-dimensional rectangular array of M*M, a center-to-center distance between two adjacent conductive sheets is equal, or an edge-to-edge distance between two adjacent conductive sheets is equal. M may be 4, 5, 6 or an integer greater than 6. In the embodiments of the disclosure, the shape of the conductive sheet 281b, and the value of M are not further limited.

It should be noted that the center-to-center distance can be considered as a distance between the respective centers of the two adjacent conductive sheets 281b, and the edge-to-edge distance can be considered as the shortest distance between edges of the two adjacent conductive sheets 281b.

In the embodiment, by arranging the conductive array assembly 280 in a two-dimensional rectangular array of M*M where the conductive sheets 281b gradually change in two dimensions, the impedance bandwidth and gain of the antenna packaging module can be improved simultaneously, a beam width of a main lobe of the antenna packaging module is diminished, and a directionality of the antenna packaging module is enhanced.

The center distance can be understood as the spacing between the respective centers of the two adjacent conductive sheets 281b; the edge distance can be understood as the shortest spacing between the edges of the two adjacent conductive sheets 281b.

In this embodiment, by arranging the conductive array assembly 280 in a two-dimensional rectangular array of M*M where the conductive sheets 281b gradually change in two dimensions, the impedance bandwidth and gain of the antenna packaging module can be improved simultaneously, a beam width of a main lobe of the antenna packaging module can be diminished, and a directionality of the antenna packaging module can be enhanced.

As illustrated in FIG. 4, an antenna packaging module provided in an embodiment includes an antenna substrate 210, a first laminated circuit 220, a ground layer 230, a radiator 240, a second laminated circuit 250, a feed structure 260, and a conductive array assembly 280. The antenna substrate 210, the first laminated circuit 220 and the second laminated circuit 250 are laminated by a PCB of 8-layer millimeter wave package antenna integrated by the High Density Interconnect (HDI) process. The first laminated circuit 220 includes metal layers TM1˜TM4, and PP layers (including PP1˜PP3) between the adjacent metal layers. The metal layers TM1˜TM4 are the copper layers of the antenna. The metal layer TM4 can be considered as a first conductive layer 221 of the first laminated circuit 220 which is adjacent to a side of the antenna substrate 210.

The radiator 240 is arranged above the metal layer TM1.

The metal layer TM5 is the ground layer 230.

The second laminated circuit 250 includes metal layers TM6˜TM8 and PP layers (including PP4˜PP6) between adjacent metal layer. The metal layers TM6˜TM8 are copper layers of the wiring in a feed network and control lines the antenna package module, and the radio frequency chip 270 is soldered to the TM8.

It should be noted that PP1˜PP6 are semi-cured sheets disposed between two metal layer s TM (such as copper layers), which separates the two copper layers and make the two copper layers adhere.

By introducing the conductive array assembly 280 (a number of periodically spaced conductive sheets 281b located at TM4 and a conductive column 281a extending through the antenna substrate 210) in the metal layer TM4 and the antenna substrate 210 to connect with TM5 (the ground layer 230), therefore TM5 is the ground layer of the radiator 240, surface waves can be suppressed, thereby improving the antenna radiation efficiency and the antenna gain. Meanwhile, the introduced conductive array assembly 280, which can be considered a number of parallel LC circuits, can improve the impedance bandwidth of the antenna and enhance isolation between ports of the antenna. By introducing the conductive array assembly 280, size of the radiator 240 along a non-scanning direction can be reduced, thereby reducing a volume of the entire antenna packaging module.

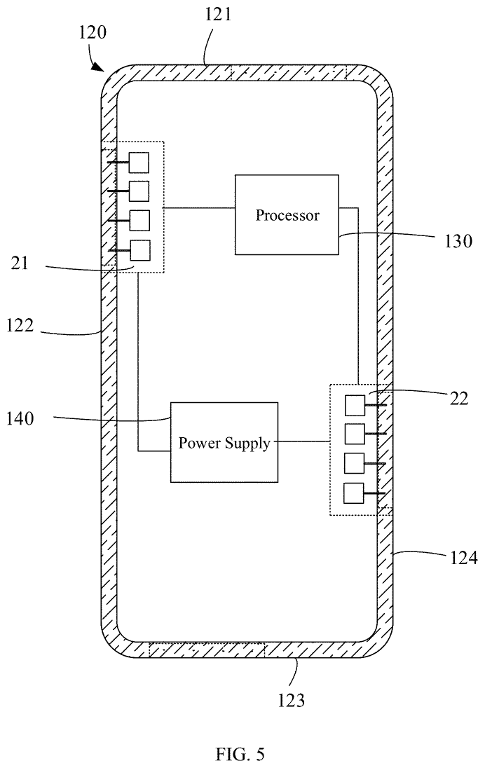

As illustrated in FIG. 5, an electronic device includes a housing and an antenna packaging module of any of the above embodiments, and the antenna packaging module is accommodated in the housing.

In an embodiment, the electronic device includes at least two of the antenna packaging modules 21, 22 which are disposed on different sides of the housing, respectively. The electronic device includes a processor 130 and a power supply 140. The processor 130 and the power supply 140 are connected to the antenna packaging modules, respectively. For example, the housing includes a first edge 121, a third edge 123 opposite to the first edge 121, a second edge 122, and a fourth edge 124 opposite to the second edge 122. The second edge 122 is connected to an end of the first edge 121 and an end of the third edge 123, and the fourth edge 124 is connected to the first edge 121 and the other end of the third edge 123. Millimeter wave modules are respectively disposed on at least two of the first edge 121, the second edge 122, the third edge 123 and the fourth edge 124. In a condition that there are two antenna packaging modules 21, 22, the antenna packaging module 21 is disposed on the second edge 122, and the antenna packaging module 22 is disposed on the fourth edge 124, thereby reducing an overall size of the antenna packaging module in the non-scanning direction and making it possible to place the antenna packaging module on both sides of the electronic device.

The electronic device with the antenna packaging module of any of the above embodiments can be used to receive and transmit the millimeter wave signals for 5G communications, improve distortions of directional map and impedance bandwidth of the antenna packaging module, enhance the radiation efficiency and radiation gain of the millimeter wave signals, and reduce the space occupied by the antenna packaging module in the electronic device.

The electronic device may include a mobile phone, a tablet computer, a notebook computer, a palmtop computer, a mobile internet device (MID), a wearable device (such as a smart watch, a smart bracelet, a pedometer, and so on) or other communication modules provided with an antenna.

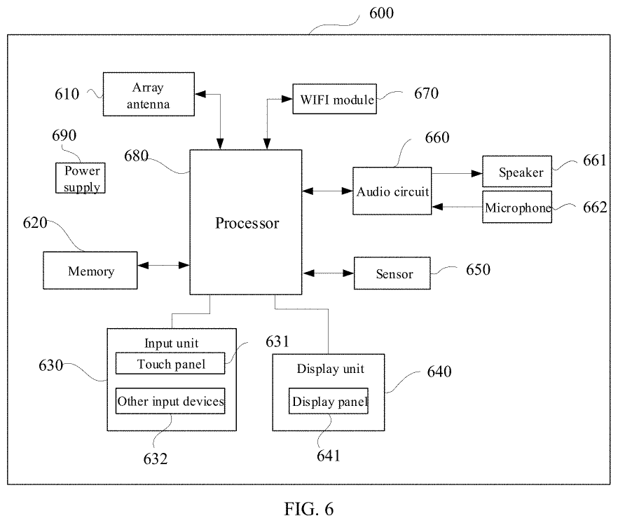

FIG. 6 is a block diagram of a partial structure of a mobile phone related to an electronic device according to an embodiment of the present disclosure. As illustrated in FIG. 6, the mobile phone 600 includes: an array antenna 610, a memory 620, an input unit 630, a display unit 640, a sensor 650, an audio circuit 660, a wireless fidelity (WIFI) module 670, a processor 680, a power supply 690 and other components. It should be understood by those skilled in related art that the structure of the mobile phone illustrated in FIG. 6 is not construed to limit the mobile phone, and may include more or less components than the components illustrated, or combine some components, or have different component arrangements.

The array antenna 610 may be used for receiving and transmitting signals in the process of receiving and transmitting information or calling. After receiving a downlink information of a base station, the array antenna 610 may transmit the information to the processor 680, or, the array antenna 610 may transmit an uplink data to the base station. The memory 620 may be configured to store software programs and modules, and the processor 680 may perform various function applications and data processing of the mobile phone by running the software programs and modules stored in the memory 620. The memory 620 may mainly include a program memory area and a data memory area. The program memory area may store an operating system, an application program required for at least one function (such as an application program for sound playing function, an application program for image playing function). The data memory area may store data (such as audio data, address book, and so on) created according to the use of the mobile phone, and so on. In addition, the memory 620 may include a high-speed random access memory and may further include a non-volatile memory, such as at least one disk memory member, a flash memory member, or other volatile solid memory members.

The input unit 630 may be used to receive input digital or character information, and generate a key signal input related to the user setting and the function control of the mobile phone 600. In an embodiment, the input unit 630 may include a touch panel 631 and other input devices 632. The touch panel 631 also known as a touch screen, may collect user's touch operations on or near it (such as user's operations on or near the touch panel 631 with any suitable object or accessory such as a finger, a touch pen), and drive a corresponding connection device according to a preset program. In an embodiment, the touch panel 631 may include two parts: a touch measuring device and a touch controller. The touch measuring device measures a touch orientation of the user, measures a signal brought by the touch operation, and transmits the signal to the touch controller. The touch controller receives touch information from the touch measuring device, converts it into a contact coordinate, then sends it to the processor 680, and receives and executes a command sent by the processor 680. In addition, various kinds of touch panels 631 may be realized, such as a resistance touch panel, a capacitance touch panel, an infrared touch panel and a surface-acoustic-wave touch panel. Besides the touch panel 631, the input unit 630 may further include other input devices 632. In an embodiment, the other input devices 632 may include, but are not limited to, one or more of a physical keyboard, and a function key (such as a volume control key, a switch key, and so on).

The display unit 640 may be used to display information that is input by the user or provided to the user and various menus of the mobile phone. The display unit 640 may include a display panel 641. In an embodiment, the display panel 641 may be configured in a form of a liquid crystal display (LCD), an organic light-emitting diode (OLED), and so on. In an embodiment, the touch panel 631 may cover the display panel 641. When the touch panel 631 measures a touch operation on or near it, the touch operation is transmitted to the processor 680 to determine a type of the touch operation. Then, the processor 680 provides a corresponding visual output on the display panel 641 according to the type of touch operation. Although in FIG. 6, the touch panel 631 and the display panel 641 serve as two independent components to realize the input and input functions of the mobile phone, the touch panel 631 and the display panel 641 may be integrated to realize the input and output functions of the mobile phone in some embodiments.

The mobile phone 600 may further include at least one sensor 650, such as an optical sensor, a motion sensor, and other sensors. In an embodiment, the light sensor may include an ambient light sensor and a proximity sensor. The ambient light sensor may adjust a brightness of the display panel 641 according to the light and shade of an ambient light, and the proximity sensor may turn off the display panel 641 and/or the backlight when the mobile phone moves to an ear. The motion sensor may include an acceleration sensor, which may measure accelerations in all directions. When the motion sensor stays still, it may measure a magnitude and a direction of gravity, which may be used to applications identifying a mobile phone posture (such as a horizontal and vertical screen switching), and functions related to vibration identification (such as a pedometer, a percussion), and so on. In addition, the mobile phone may be provided with a gyroscope, a barometer, a hygrometer, a thermometer, an infrared sensor and other sensors.

An audio circuit 660, a speaker 661 and a microphone 662 may provide an audio interface between the user and the mobile phone. The audio circuit 660 may transmit an electrical signal converted from the received audio data to the speaker 661, and the speaker 661 converts the electrical signal to a sound signal to be output. On the other hand, the microphone 662 converts a collected audio signal into an electrical signal, the audio circuit 660 receives the electrical signal and converts the electrical signal into audio data, and the audio data is output to the processor 680 to be processed. Then, the processed audio date is sent to another mobile phone by the array antenna 610, or output to the memory 620 for subsequent processing.

The processor 680 is a control center of the mobile phone, which uses various interfaces and lines to connect all parts of the mobile phone, and performs various functions of the mobile phone and processes data by running or executing software programs and/or modules stored in the memory 620 and invoking data stored in the memory 620, so as to overall monitor the mobile phone. In an embodiment, the processor 680 may include one or more processing units. In an embodiment, the processor 680 may integrate an application processor and a modulating-demodulating processor. The application processor mainly processes an operating system, a user interface, an application program, and so on. The modulating-demodulating processor mainly processes a wireless communication. It should be understood that the above modulating-demodulating processor may not be integrated into the processor 680.

The mobile phone 600 further includes a power supply 690 (such as a battery) for supplying power to each component. In some embodiments, the power supply may be logically connected to the processor 680 through a power management system, so as to realize functions of charging, discharging, and power consumption management through the power management system.

In an embodiment, the mobile phone 600 may further include a camera, a Bluetooth module, and so on.

Any reference to a memory, a storage, a database or other media used in the disclosure may include a non-volatile and/or volatile memory. A suitable non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM), which is used as an external cache memory. The RAM may be obtained in many forms, such as static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a rambus direct random access memory (RDRAM), a direct rambus dynamic random access memory (DRDRAM), and a rambus dynamic random access memory (RDRAM).

Respective technical features of the above embodiments may be combined arbitrarily. In order to make the description concise, not all possible combinations of the respective technical features in the above embodiments have been described. However, as long as the combinations of these technical features do not have contradictions, they should be considered to be fallen into the scope of the description.

The above embodiments only illustrate several implementations of the disclosure, and the descriptions thereof are specific and detailed, but it cannot not be understood as limiting the protection scope of the disclosure. It should be noted that, for those skilled in the related art, several modifications and variants can be made without departing from the principle of the disclosure, which belong to the protection scope of the present disclosure. Therefore, the protection scope of the patent of the disclosure shall be subject to the appended claims.

What is claimed is:

1. An antenna packaging module, comprising:
an antenna substrate, wherein a first laminated circuit and a ground layer are disposed on two opposite sides of the antenna substrate, respectively;
a radiator disposed on a side of the first laminated circuit away from the antenna substrate;
a second laminated circuit disposed on a side of the ground layer away from the antenna substrate;
a feed structure extending through the second laminated circuit, the ground layer, the antenna substrate and the first laminated circuit, the feed structure being configured to electrically connect a radio frequency chip and the radiator; and
a conductive array assembly wherein the conductive array assembly comprises a plurality of conductive structures, the conductive structures extend through the antenna substrate and are electrically connected with the ground layer, and a portion of the feed structure is disposed in a space formed by two adjacent conductive structures.

2. The antenna packaging module as claimed in claim 1, wherein the first laminated circuit comprises a first conductive layer adjacent to a side of the antenna substrate.

3. The antenna packaging module as claimed in claim 2, wherein each of the conductive structures comprises a conductive column extending through the antenna substrate and a conductive sheet disposed on the first conductive layer, and the conductive sheet is electrically connected to the ground layer via the conductive column.

4. The antenna packaging module as claimed in claim 3, wherein a plurality of conductive sheets are periodically arranged on the first conductive layer.

5. The antenna packaging module as claimed in claim 4, wherein the periodically arranged conductive sheets are rotationally or axially symmetric in a plane.

6. The antenna packaging module as claimed in claim 4, wherein the periodically arranged conductive sheets are same in shape.

7. The antenna packaging module as claimed in claim 3, an area of the conductive sheet located at a center of the conductive array assembly is largest, and areas of the conductive sheets decrease gradually along a direction from the center to a periphery.

8. The antenna packaging module as claimed in claim 4, wherein areas of the periodically arranged conductive sheets in each row decrease along a same direction, or areas of the periodically arranged conductive sheets in each row increase along a same direction.

9. The antenna packaging module as claimed in claim 4, wherein an area of each of the periodically arranged conductive sheets is equal.

10. The antenna packaging module as claimed in claim 3, wherein a center-to-center distance between two adjacent conductive sheets is equal, or an edge-to-edge distance between two adjacent conductive sheets is equal.

11. The antenna packaging module as claimed in claim 3, wherein a shape of a cross section of the conductive column along a plane of the antenna substrate is a same as a shape of the conductive sheet connected to the conductive column.

12. The antenna packaging module as claimed in claim 3, wherein an area of the conductive sheet is larger than an area of a cross section of the conductive column, where the cross section is along a plane of the antenna substrate.

13. The antenna packaging module as claimed in claim 1, wherein the second laminated circuit, the ground layer, the antenna substrate and the first laminated circuit define a plurality of through holes therein, and the feed structure is disposed in the through holes.

14. The antenna packaging module as claimed in claim 1, wherein the radiator is an antenna array formed by a plurality of antennas, each of which is selected from at least one type of a patch antenna, a dipole antenna and a yagi antenna.

15. An electronic device, comprising:
a housing; and
an antenna packaging module accommodated in the housing, wherein the antenna packaging module comprises:
an antenna substrate, wherein a first laminated circuit and a ground layer are disposed on two opposite sides of the antenna substrate, respectively;
a radiator disposed on a side of the first laminated circuit away from the antenna substrate;
a second laminated circuit disposed on a side of the ground layer away from the antenna substrate, a side of the second laminated circuit away from the ground layer being configured to dispose a radio frequency chip;
a feed structure, wherein the feed structure extends through the second laminated circuit, the ground layer, the antenna substrate and the first laminated circuit, and the feed structure is configured to electronically connect the radio frequency chip and the radiator; and
a plurality of conductive structures, wherein the conductive structures extend through two opposite sides of the antenna substrate and are connected with the ground layer, and a portion of the feed structure is disposed between two adjacent conductive structures.

16. The electronic device as claimed in claim 15, wherein the plurality of conductive structures is equally spaced apart from each other.

17. The electronic device as claimed in claim 15, wherein the first laminated circuit comprises a first conductive layer adjacent to a side of the antenna substrate, the each of the conductive structures comprises a conductive column extending through the antenna substrate and a conductive sheet corresponding to the conductive column, the conductive sheet is disposed on the first conductive layer and connected to the ground layer via the conductive column.

18. The electronic device as claimed in claim 17, wherein a plurality of conductive sheets is periodically arranged on the first conductive layer; and the periodically arranged conductive sheets are rotationally symmetric or axially symmetric in a plane.

19. The electronic device of claim 15, wherein the electronic device comprises at least two of the antenna packaging modules;
the housing comprises a first edge, a third edge opposite to the first edge, a second edge, and a fourth edge opposite to the second edge, the second edge is connected to an end of the first edge and an end of the third edge, the fourth edge is connected to an other end of the first edge and the other end of the third edge; and
the antenna packaging modules are respectively disposed on at least two of the first edge, the second edge, the third edge and the fourth edge.

20. An antenna packaging module, comprising:
an antenna substrate, wherein a first laminated circuit and a ground layer are disposed on two opposite sides of the antenna substrate, respectively, and the first laminated circuit comprises a first conductive layer adjacent to a side of the antenna substrate;
a radiator disposed on a side of the first laminated circuit away from the antenna substrate;
a second laminated circuit disposed on a side of the ground layer away from the antenna substrate, wherein a side of the second laminated circuit away from the ground layer is configured to dispose a radio frequency chip;
a plurality of equally spaced conductive structures, wherein each of the conductive structures extends through the antenna substrate and is spaced from each other, each of the conductive structure comprises a conductive column and a conductive sheet disposed on the first conductive layer, and both the conductive sheet and the ground layer electronically connect the conductive column; and
a feed structure extending through the second laminated circuit, the ground layer, the antenna substrate and the first laminated circuit, wherein the feed structure is configured to electronically connect the radio frequency chip and the radiator; and a portion of the feed structure is disposed between two adjacent conductive structures.
